(19) United States
(12) Patent Application Publication
(10) Pub. No.: US 2014/0188875 A1
(43) Pub. Date: Jul. 3, 2014

(54) METHOD FOR MEASURING COEFFICIENT OF CONTACTS OF ONLINE SOCIAL NETWORK

(71) Applicant: Tao Hong, Shanghai (CN)

(72) Inventor: Tao Hong, Shanghai (CN)

(21) Appl. No.: 14/116,912

(22) PCT Filed: Sep. 9, 2011
(86) PCT No.: PCT/CN2011/001533

§ 371 Date: Mar. 4, 2014

(30) Foreign Application Priority Data
May 10, 2011 (CN) 201110119938.1
Aug. 18, 2011 (CN) 201110236923.3

(51) Int. Cl. G06F 17/30

(52) U.S. Cl. CPC G06F 17/30861; G06F 17/30327
USPC 707/736

(57) ABSTRACT

The present disclosure relates to online social networks. In particularly it is relates to a method for measuring coefficient of contacts of online social network. A method for measuring coefficient of contacts of online social network comprises the following steps that: the social network comprises at least one tree system, the sum of the coefficients of contacts of each tree system is 1, and the tree system is composed of root-level users, trunk-level users and leaf-level users; each user in the social network belongs to a unique tree system and has a unique code; the leaf-level user has no subordinate relationship of contacts, thus the coefficient of contacts of the leaf-level user is zero; the coefficient of contacts of each of the trunk-level users of the tree system is as follows: Si=ΣSi+1+j/n/(i+1). The whole situation of contacts and specific situation of contacts of any group can be evaluated quantitatively in social network sites, so as to provide the basis for commercial activities and social media activities of the social network sites.

### TECHNICAL FIELD

The present disclosure relates to online social networks. In particularly it is relates to a method for measuring coefficient of contacts of online social network.

### DESCRIPTION OF RELATED ART

Online social networks connect the users who have common background or interest, promoting the users to communicate with each other by electronic message boards, forums or mail, and enhancing linkages and interactions between the users.

Throughout the expanding mode of present social network sites, there is nothing more than a flat type introduction of reputation, that a person registered in the website sends a link or search for names to invite their friends , colleagues and relatives to join it; or through the logic and algorithms built in the website people who have commonalities are linked with each other, that is in the website all registered people establish connections by searching concerned people actively or accept the invitation passively through the same education, work, community and so on.

The profit model of social network sites is interesting the businesses in advertising to get ad revenue through increasing the click traffic of the site, and it is very vague that the click traffic of the site is used to measure the coefficient of contacts of social network sites so the whole situation of contacts and specific situation of contacts of a group can not be evaluated quantitatively in social network sites, and thus the business value of the social network sites can not be quantified assess. It is very important to assess the contacts situation of social network sites for both the businesses and the Web site operators, because the contacts situation of social network site may affect businesses whether to advertise or not and the scale. It is also necessary to measure contacts situation of the specific group of social network sites quantitatively, because it plays an important role in the case of the distribution of benefits or information transaction of social network sites internal or external.

### BRIEF SUMMARY

Thereby, the objective of the present disclosure is to provide a method for measuring coefficient of contacts of online social network, which the whole situation of contacts and specific situation of contacts of any group can be evaluated quantitatively in social network sites, so as to provide the basis for commercial activities and social media activities of the social network sites.

The present disclosure provides a technical solution as following:

A method for measuring coefficient of contacts of online social network comprises the following steps that:

the social network comprises at least one tree system, the sum of the coefficients of contacts of each tree system is 1, and the tree system is composed of root-level users, trunk-level users and leaf-level users;

each user in the social network belongs to a unique tree system and has a unique code;

initial user (so called root-level user) registers to this tree-structured social network;

root-level user introduces trunk-level or leaf-level user to register;

trunk-level user introduces trunk-level or leaf-level user to register, the leaf-level user has no subordinate relationship of contacts, thus the coefficient of contacts of the leaf-level user is zero;

the coefficient of contacts of each of the trunk-level users of the tree system is as follows: Si=ΣSi+1+j/n/(i+1),where n stands for the total number of users in the tree system, i stands for the layer of the target trunk-level user, j stands for the total number of users below the target trunk-level user's layer(i.e. layer i+1).

A method for measuring coefficient of contacts of online social network comprises the following steps that:

the social network comprises at least one tree system, the sum of the coefficients of contacts of each tree system is 1, and the tree system is composed of root-level users, trunk-level users and leaf-level users;

each user in the social network belongs to a unique tree system and has a unique code;

initial user (so called root-level user) registers to this tree-structured social network;

root-level user introduces trunk-level or leaf-level user to register;

trunk-level user introduces trunk-level or leaf-level user to register, the leaf-level user has no subordinate relationship of contacts, thus the coefficient of contacts of the leaf-level user is zero;

root-level user belongs to layer 0, the coefficient of contacts of the root-level user of the tree system is as follows: S0=ΣS1+j/n+1/n, where n stands for the total number of users in the tree system, i stands for the layer of the trunk-level user, j stands for the total number of users below root-level user.

The present disclosure has the advantages that:

1. The present disclosure uses a tree structure of the coefficient management, so the whole contacts structure of the social network is very clear and precise, only three roles, the roots, trunk and leaves, facilitating the measurements of coefficient of contacts.

2. The present disclosure uses a recursive algorithm to calculate the coefficient of contacts, and in the tree system each user has a network points which obtained from multiplying the number of users of the whole tree by the coefficient (s) which calculated according to the level and the number of subordinate users. The coefficient of contacts is a dynamic coefficient value, which varies according to levels and number of users of the whole tree. The only constant is that the sum of coefficient of contacts of all the users in the tree is 1.

3. In the present disclosure, the coefficient of contacts indicates the potential commercial value of each user in the social network quantitatively so as to provide the value basis for commercial activities and social media activities of the social network sites.

### BRIEF DESCRIPTION OF THE DRAWINGS

FIG. 1 illustrates the structure of the tree in present disclosure.

FIG. 2 illustrates the contacts transferring of management of the contacts in the structure of the tree in present disclosure.

### DETAILED DESCRIPTION

The present disclosure is further described in detail with reference to the attached drawings and the embodiment.

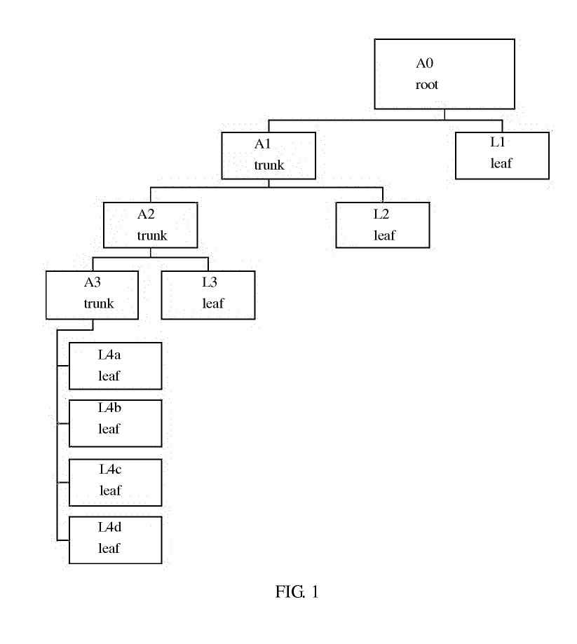

In FIG. 1, as the initial user of the tree system, the root-level user developed the trunk-level user A1 as the first layer of the tree system and the leaf-level user L1. The trunk-level user A1 developed the trunk-level user A2 as the second layer of the tree system and the leaf-level user L2. The trunk-level user A2 developed the trunk-level user A3 as the third layer of the tree system and the leaf-level user L3. The trunk-level user A3 developed four leaf-level users L4. Thus there are eleven users in the tree, in which seven users are leaf-level users. The trunk-level users and root-level user have their coefficients of contacts respectively.

There are eleven users in the tree system, so the number of users n=11, and the tree system has five layers, so the number of layer m=5.

The users who starts with an L are the leaf-level users whose coefficients of contacts are 0, and the 1/11 of the corresponding coefficients are allocated back to the trunk-level users or root-level user they belongs to.

Each of the four leaf-level users L4a, L4b, L4c and L4d bringing coefficient of contacts to its upper layer user A3 is 1/[n×(i+1)],i.e. 1/44.

So the coefficient of contacts A3 is SA3=1/44+1/44+1/44+1/44=1/11=0.09.

L3 brings 1/33 coefficient of contacts to its upper layer user A2.

The coefficient of contacts A2 is SA2=SA3+1/33+1/33=0.15.

L2 brings 1/22 coefficient of contacts to its upper layer user A1.

The coefficient of contacts A1 is SA1=SA2+1/22+1/22=0.24.

L1 brings 1/11 coefficient of contacts to its upper layer user root-level user A0.

The coefficient of contacts A0 is SA0=SA1+1/11+1/11+1/11=0.52.

The sum of the coefficients of contacts is 1.

The sum of the network points is 11 (network point=coefficients of contacts×number of users of the tree).

The network point of A0 is 5, and the network point of A1 is 3, and the network point of A2 is 2, and the network point of A3 is 1.

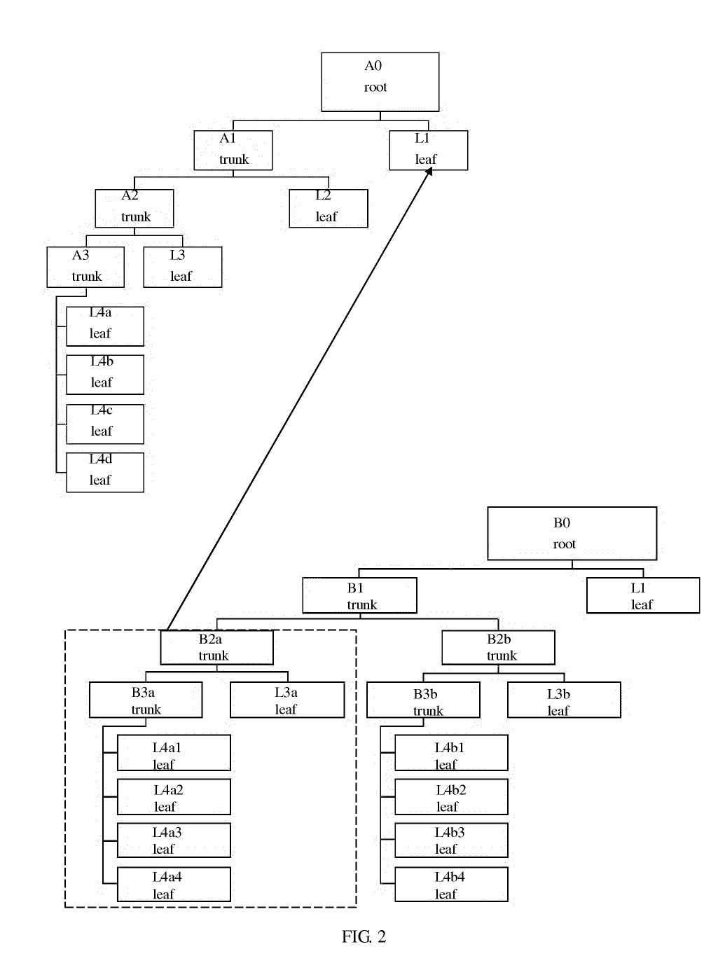

In FIG. 2, tree systems A and B have complete root, trunks and leaves structure, and each tree system has its coefficient of contacts and network point. First, the leaf-level user L4 of the tree system A wants to merger the second layer trunk-level user B2a and all its subordinate veins of the tree system B (parts lined out by the dashed line in FIG. 2), and L1 and trunk-level user B1 must be negotiated transfer price and other transfer issues. The coefficient of contacts and network point of B1 may be the basis of the transfer price and transfer terms.

The users in the same tree system can also be transferred or exchanged according to the rules above. If A1 of tree system A want to be a root-level user of a new tree independently, A1 should be negotiated the transfer price and other transfer issues with the root-level user A0. After transferred the coefficient of contacts and network points in the same tree system should be adjusted.

In FIG. 1, if the tree system gets 110 thousand advertising, after meeting the delivery requirements of all the owners of the ads, the entire tree system will get the corresponding advertising revenues. Income distribution will be based on the coefficient of contacts all users: the income of the root-level user A0 is equal to its coefficient of contacts multiplied by the total income of adverting (=110 thousand×5/11=50 thousand); and the income of the trunk-level user A1 is equal to 110 thousand×3/11=30 thousand; and the income of the trunk-level user A2 is equal to 110 thousand×2/11=20 thousand; and the income of the trunk-level user A3 is equal to 110 thousand×1/11=10 thousand. So that the commercial value in the tree system has been mongered and distributed effectively and reasonably.

The invention utilizes a tree-structured system to develop social network. The method in the invention is capable of quickly and quantitatively measuring the coefficient of contacts of the entire online social network, thereby providing the critical links within information <-> relationship chain <-> interaction. Initial user (root-level user A0) registers and forms its individual social network environment. The root-level user contacts potential users and invites them to register under its tree family, after successful registration, the potential users then become the leaf-level users. Once the leaf-level user develops its own subordinate users, it is qualified as trunk-level user (A1). If the leaf-level user doesn't develop any subordinate user, then it stays as leaf-level user (L1).Trunk-level user A1 develops next layer of trunk-level user (A2) and leaf-level user (L2), and so forth. The whole social network system is well structured; there are only 3 roles in the system: root, trunk and leaf, easy for management.

The Tree-Structured Network Management has below advantages:

1) UNIQUENESS: Every user in the tree-structured social network only belongs to one unique tree family, thus counted only once in the whole system, and must have a certain role(root, trunk or leaf).

2) NORMALIZATION: In the tree system each user has a network points which obtained from multiplying the number of users of the whole tree by the coefficient (s) which calculated according to the level and the number of subordinate users. The coefficient of contacts is a dynamic coefficient value, which varies according to levels and number of users of the whole tree. The only constant is that the total coefficient of contacts of all the users in the tree add up to ONE (Si=1), that is the sum of the network points is equal to the number of users of the tree. It should be noted that any leaf-level user in the tree whose coefficient of contacts is 0, i.e. no network points.

3) TRANSFERABILITY: Users within the same tree family as well as between different tree families can transfer or exchange networks, the coefficients and network points (NP) are refreshed afterwards. It should be noted that each transfer event to be transferred by the upper layer □ trunk or root level user to operate.

Commercial application: As an innovative and critical method to link the social network information flow and relationship development, the invention relates a method for measuring the coefficient of users within online social network, thus provides an objective and quantitative measurement for commercial applications, includes but not limited to advertisement, digital business, mobile phone applications, etc.

1. A method for measuring coefficient of contacts of online social network comprises the following steps:
providing or accessing the social network, wherein the social network comprises at least one tree system, the sum of the coefficients of contacts of each tree system is 1, and the tree system is composed of root-level users, trunk-level users and leaf-level users;
wherein each user in the social network belongs to a unique tree system and has a unique code;
registering an initial root-level user to this tree-structured social network;
the root-level user introducing a trunk-level or leaf-level user to register;
the trunk-level user introducing a trunk-level or leaf-level user to register, wherein the leaf-level user has no subordinate relationship of contacts, thus the coefficient of contacts of the leaf-level user is zero;
the trunk-level user introducing trunk-level users below or leaf-level users;
providing the coefficient of contacts of each of the trunk-level users of the tree system as follows: Si=ΣSi+1+j/n/(i+1),where n stands for the total number of users in the tree system, i stands for the layer of the target trunk-level user, j stands for the total number of users below the target trunk-level user's layer.

2. A method for measuring coefficient of contacts of online social network comprises the following steps:
providing or accessing the social network, wherein the social network comprises at least one tree system, the sum of the coefficients of contacts of each tree system is 1, and the tree system is composed of root-level users, trunk-level users and leaf-level users;
wherein each user in the social network belongs to a unique tree system and has a unique code;
registering an initial root-level user to this tree-structured social network;
the root-level user introducing a trunk-level or leaf-level user to register;
the trunk-level user introducing trunk-level or leaf-level user to register, wherein the leaf-level user has no subordinate relationship of contacts, thus the coefficient of contacts of the leaf-level user is zero;
the trunk-level user introducing trunk-level users below or leaf-level users;
wherein the root-level user belongs to layer 0, providing the coefficient of contacts of the root-level user of the tree system is as follows: S0=ΣS1+j/n+1/n, where n stands for the total number of users in the tree system, i stands for the layer of the trunk-level user, j stands for the total number of users below root-level user.

3. The method for measuring coefficient of contacts of online social network according to claim 1, comprising creating labels, iterations and stories for root-level users, trunk-level users and leaf-level users, wherein each user has its own unique ID, coefficient (S), and profile.

4. The method for measuring coefficient of contacts of online social network according to claim 1, comprising creating guild and conversation environments for SNS tools.

5. The method for measuring coefficient of contacts of online social network according to claim 1, comprising providing a commercial service platform providing proactive search and match for the users to realize commercial value via tree-structured iteration, and distributed within family users accordingly.

6. The method for measuring coefficient of contacts of online social network according to claim 2, comprising providing labels, iterations and stories for root-level users, trunk-level users and leaf-level users, wherein each user has its own unique ID, coefficient (S), and profile.

7. The method for measuring coefficient of contacts of online social network according to claim 2, further comprising providing guild and conversation environment for SNS tools.

8. The method for measuring coefficient of contacts of online social network according to claim 2, comprising providing a commercial service platform providing proactive search and match for the users to realize commercial value via tree-structured iteration, and distributed within family users accordingly.
